(19) United States
(12) Patent Application Publication
(10) Pub. No.: US 2026/0097625 A1
(43) Pub. Date: Apr. 9, 2026

(54) DUCT DOCKING APPARATUS FOR VENTILATION SEAT OF VEHICLE

(71) Applicants: Hyundai Motor Company, Seoul (KR); Kia Corporation, Seoul (KR); Lear Korea Limited Liability Company, Seoul (KR); KBAUTOTECDH CO., LTD., Asan-Si (KR)

(72) Inventors: Han Kyeol Cho, Hwaseong-Si (KR); Ho Suk Jung, Hwaseong-Si (KR); Hyeok Seung Lee, Hwaseong-Si (KR); Ju Yeol Kong, Hwaseong-Si (KR); Mu Young Kim, Hwaseong-Si (KR); Chan Ho Jung, Hwaseong-Si (KR); Sang Man Seo, Hwaseong-Si (KR); Soon Man Jang, Seoul (KR); Ryu Seok Ko, Gwangmyeong-Si (KR); Byoung Su You, Siheung-Si (KR); Hyun Mok Kim, Seoul (KR); Sung Ryeol Choi, Seoul (KR); Tae Soo Sung, Asan-Si (KR); Min Woo Joo, Asan-Si (KR)

(21) Appl. No.: 19/241,802

(22) Filed: Jun. 18, 2025

(30) Foreign Application Priority Data
Oct. 7, 2024 (KR) 10-2024-0135562

(51) Int. Cl. B60H 1/00; B60N 2/20; B60N 2/56

(52) U.S. Cl. CPC B60H 1/00564; B60N 2/20; B60N 2/5657

(57) ABSTRACT

An apparatus for a ventilation seat of a vehicle is introduced. The apparatus may comprise a seat cushion duct divided into a first seat cushion duct and a second seat cushion duct, configured to supply air to a seat cushion, and a blower mounted between the first seat cushion duct and the second seat cushion duct, configured to blow air into the seat cushion duct. The apparatus further comprises a seatback duct mounted at a seatback, rotatably connected to the seat cushion, wherein the seatback duct is configured to be communicably docked to the seat cushion duct based on the seatback rotating to an unfolded position, and separated from the seat cushion duct based on the seatback rotating to a folded position. A docking connector is configured to connect the seat cushion duct to the seatback duct and guide the docking position of the seatback duct to the seat cushion duct.

### CROSS-REFERENCE TO RELATED APPLICATION

The present application claims the benefit of priority to Korean Patent Application No. 10-2024-0135562, filed in the Korean Intellectual Property Office on Oct. 7, 2024, the entire contents of which are incorporated herein by reference.

### TECHNICAL FIELD

The present disclosure relates to a duct docking apparatus for a ventilation seat of a vehicle. More particularly, the present disclosure relates to a duct docking apparatus for a ventilation seat of a vehicle which enables a duct of the ventilation seat to be docked at an unfolded position, etc. of a seatback, and to be separated at a folded position of the seatback.

### BACKGROUND

The matters described in this Background section are only for enhancement of understanding of the background of the disclosure, and should not be taken as acknowledgment that they correspond to prior art already known to those skilled in the art. Generally, a ventilated seat for a vehicle is a kind of a convenience feature configured to allow air generated by a blower to be blown to air discharge holes in a seat cushion and seatback through a duct to quickly remove heat and moisture from the bottom and back of a passenger seating in the seat, providing a cool and comfortable seating experience.

To achieve this, a blower for supplying cold air and a duct serving as an air passage may be installed within the ventilated seat, directing air from the blower to the air discharge holes in the seat cushion and seatback. In foldable seat configurations, such as those in SUVs, movement of the seat back during folding may disrupt connections between ducts, making it difficult to use a single blower for both the seat cushion and seatback. As a result, separate blowers may be required for each section, adding complexity, weight, and cost to the system.

### SUMMARY

Other examples and examples of the present disclosure are discussed infra.

According to the present disclosure, an apparatus for a ventilation seat of a vehicle, the apparatus may comprise a seat cushion duct divided into a first seat cushion duct and a second seat cushion duct, and configured to supply air to a seat cushion, a blower mounted between the first seat cushion duct and the second seat cushion duct, and configured to blow air into the seat cushion duct, a seatback duct mounted at a seatback, which is rotatably connected to the seat cushion, wherein the seatback duct is configured to be based on the seatback rotating to an unfolded position, communicably docked to the seat cushion duct, and based on the seatback rotating to a folded position, separated from the seat cushion duct, and a docking connector configured to connect the seat cushion duct to the seatback duct, and guide, based on the seatback rotating to the unfolded position, a docking position of the seatback duct to the seat cushion duct.

The apparatus, wherein the docking connector may comprise a body connected to the seat cushion duct, a docking guide rotatably coupled to the body and may comprise a communication hole configured to enable the seatback duct to be communicably docked, and an elastic member configured to elastically support a guide pin formed on the docking guide, and provide an elastic force to rotate the docking guide from the body based on the seatback being switched to the folded position and separated from the seat cushion duct. The apparatus, wherein the body may comprise a guide slot into which the guide pin is inserted, and wherein the guide slot is configured to set a rotation path of the docking guide rotated by the elastic member.

The apparatus, wherein the docking guide may comprise an inlet portion formed by the communication hole, wherein the inlet portion has a stepped shape with an inclined surface that widens along a lengthwise direction of the inlet portion, and wherein the inclined surface guides the seatback duct to alignment with the communication hole.

The apparatus, wherein the seatback duct may comprise, based on the seatback duct being communicably docked to the seat cushion duct, a sealing member, positioned at a border between the communication hole and the inlet portion, configured to maintain airtightness.

The apparatus, wherein the sealing member is positioned inside the communication hole based on the seatback being further rotated in the unfolded position and a coupling amount for docking the seatback duct increasing, wherein the coupling amount corresponds to an extent to which the seatback duct is coupled with the communication hole.

The apparatus, wherein the seatback duct is mounted at a center of the seatback, and wherein the seatback duct is docked in a straight direction to the seat cushion duct mounted at a center of the seat cushion through the docking connector.

The apparatus, wherein the seatback duct is provided with a fixation guide, and wherein the fixation guide is configured to fix the seatback duct in the seatback.

The apparatus, wherein the fixation guide may comprise a mounting bracket configured to support the seatback duct in a lateral direction, and an elastic member mounted to the mounting bracket and configured to elastically support the seatback duct in a forward direction perpendicular to the lateral direction.

According to the present disclosure, an apparatus for a ventilation seat of a vehicle, the apparatus may comprise a seat cushion duct divided into a first seat cushion duct and a second seat cushion duct, and configured to supply air to a seat cushion at a center of the seat cushion, a blower mounted between the first seat cushion duct and the second seat cushion duct, and configured to blow air into the seat cushion duct, a seatback duct mounted at a center of a seatback, which is rotatably connected to the seat cushion, wherein the seatback duct is configured to be based on the seatback rotating to an unfolded position, communicably docked in a straight direction to the seat cushion duct, and based on the seatback rotating to a folded position, separated from the seat cushion duct, and a docking connector configured to connect the seat cushion duct to the seatback duct, and guide, based on the seatback rotating to the unfolded position, a docking position of the seatback duct to the seat cushion duct.

The apparatus, wherein the docking connector may comprise a body connected to the seat cushion duct, a docking guide rotatably coupled to the body and may comprise a communication hole configured to enable the seatback duct to be communicably docked, and an elastic member configured to elastically support a guide pin formed on the docking guide, and provide an elastic force to rotate the docking guide from the body based on the seatback being switched to the folded position and separated from the seat cushion duct.

The apparatus, wherein the body may comprise a guide slot into which the guide pin is inserted, and wherein the guide slot is configured to set a rotation path of the docking guide rotated by the elastic member.

The apparatus, wherein the docking guide may comprise an inlet portion formed by the communication hole, wherein the inlet portion has a stepped shape with an inclined surface that widens along a lengthwise direction of the inlet portion, and wherein the inclined surface guides the seatback duct to be aligned with the communication hole.

The apparatus, wherein the seatback duct may comprise, based on the seatback duct being communicably docked to the seat cushion duct, a sealing member, positioned at a border between the communication hole and the inlet portion, configured to maintain airtightness.

The apparatus, wherein the sealing member is positioned inside the communication hole based on the seatback being further rotated in the unfolded position and a coupling amount for docking of the seatback duct increasing, wherein the coupling amount corresponds to an extent to which the seatback duct is coupled with the communication hole.

The apparatus, wherein the seatback duct is provided with a fixation guide, and wherein the fixation guide is configured to fix the seatback duct in the seatback.

The apparatus, wherein the fixation guide may comprise a mounting bracket configured to support the seatback duct in a lateral direction, and an elastic member mounted to the mounting bracket and configured to elastically support the seatback duct in a forward direction perpendicular to the lateral direction.

According to the present disclosure, a method performed by a vehicle for a ventilation seat of the vehicle, the method may comprise supplying air to a seat cushion through a seat cushion duct divided into a first seat cushion duct and a second seat cushion duct, blowing air into the seat cushion duct using a blower mounted between the first seat cushion duct and the second seat cushion duct, rotating a seatback, which is rotatably coupled to the seat cushion, to an unfolded position, wherein during the seatback being rotated to the unfolded position, a seatback duct mounted at the seatback communicably docks with the seat cushion duct to enable air flow, rotating the seatback to a folded position, wherein during the seatback being rotated to the folded position, the seatback duct separates from the seat cushion duct to discontinue air flow, and guiding, by a docking connector of the vehicle and based on rotating the seatback to the unfolded position, a docking position of the seatback duct to align with the seat cushion duct to facilitate air flow.

The method, wherein the docking connector may comprise a body connected to the seat cushion duct, a docking guide rotatably coupled to the body and may comprise a communication hole configured to enable the seatback duct to be communicably docked, and an elastic member configured to elastically support a guide pin formed on the docking guide, and provide an elastic force to rotate the docking guide from the body based on the seatback being switched to the folded position and separated from the seat cushion duct.

The method, wherein the body may comprise a guide slot into which the guide pin is inserted, and wherein the guide slot is configured to set a rotation path of the docking guide rotated by the elastic member.

It is to be understood that the term “vehicle” or “vehicular” or other similar terms as used herein are inclusive of motor vehicles in general, such as passenger automobiles including sport utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, a vehicle powered by both gasoline and electricity.

The above and other features of the present disclosure are discussed infra.

### BRIEF DESCRIPTION OF THE DRAWINGS

The above and other features of the present disclosure will now be described in detail with reference to certain examples thereof shown in the accompanying drawings which are given herein below by way of exemplary only, and thus are not limitative of the present disclosure, and wherein:

FIG. 1A, FIG. 1B, and FIG. 2 show examples of a ventilation seat;

FIG. 3 show an example of a duct docking apparatus for a ventilation seat of a vehicle according to an example of the present disclosure;

FIG. 4 and FIG. 5 show an example of an air supply path for a duct docking apparatus for a ventilation seat of a vehicle according to an example of the present disclosure;

FIG. 6 show an example of a seatback duct for a duct docking apparatus for a ventilation seat of a vehicle according to an example of the present disclosure;

FIG. 7 show an example of a docking connect for a duct docking apparatus for a ventilation seat of a vehicle according to an example of the present disclosure;

FIG. 8A and FIG. 8B show an example of the unfolded position of a seatback for a duct docking apparatus for a ventilation seat of a vehicle according to an example of the present disclosure;

FIG. 9A and FIG. 9B show an example of the rotation of a seatback for a duct docking apparatus for a ventilation seat of a vehicle according to an example of the present disclosure;

FIG. 10A and FIG. 10B show an example of the folded position of a seatback for a duct docking apparatus for a ventilation seat of a vehicle according to an example of the present disclosure; and

FIG. 11A, FIG. 11B, and FIG. 11C sequentially show an example of the docking of a seatback duct to a duct docking apparatus for a ventilation seat of a vehicle according to an example of the present disclosure.

It should be understood that the appended drawings are not necessarily to scale, presenting a somewhat simplified representation of various features showing the basic principles of the present disclosure. The specific design features of the present disclosure, including, for example, specific dimensions, orientations, locations, and shapes, will be determined in part by the particular intended application and usage environment.

In the figures, the reference numbers refer to the same or equivalent parts of the present disclosure throughout the several figures of the drawing.

### DETAILED DESCRIPTION

Hereinafter, examples according to the present disclosure will be described in detail with reference to the accompanying drawings.

Advantages and features of the present disclosure, and a method of achieving the same, will be apparent with reference to the examples described below in detail in conjunction with the accompanying drawings.

However, the present disclosure may be exemplary in many different forms, and should not be construed as being limited to the examples set forth herein. Rather, the examples are provided so that the present disclosure will be thorough and complete, and will fully convey the scope of the present disclosure to those skilled in the art. The present disclosure is defined only by the categories of the claims.

In describing the present disclosure, if a detailed explanation of a related known function or construction is considered to unnecessarily obscure the gist of the present disclosure, such explanation has been omitted but would be understood by those skilled in the art.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

According to the present disclosure, a docking duct system is introduced for ventilated car seats for managing airflow to both the seat cushion and seatback. In foldable seat configurations, such as those in SUVs, ventilated seats may use separate blowers for these sections because rotations of the seatback during folding may disrupt connections between ducts. This adds complexity, cost, and weight. The proposed solution is a docking duct structure that enables a single blower to serve both the seat cushion and seatback, even when the seatback is folded. Key components include a docking connector, docking guide, and return springs that ensure the ducts reconnect seamlessly after folding. The simplified duct paths may reduce air loss, improve airflow efficiency, and remove the need for additional blowers. This integrated design not only reduces space and costs but also enhances airflow performance and noise reduction, allowing passengers to experience faster cooling and quieter operation.

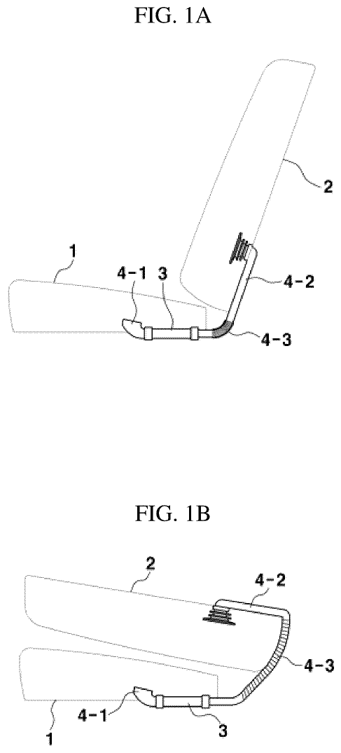

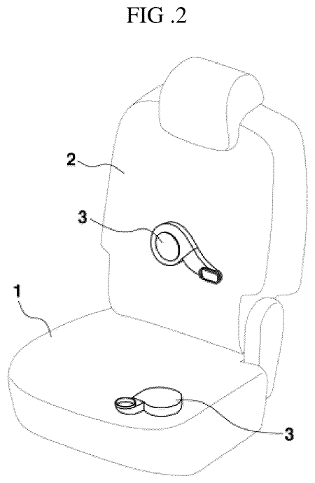

As shown in FIG. 1A and FIG. 1B, the ventilation seat comprises a blower 3 mounted at the bottom of a seat cushion 1 for air dispersion and ventilation, a first duct 4-1 configured to connect one discharge portion of the blower 3 to the seat cushion 1, and a second duct 4-2 configured to connect another discharge portion of the blower 3 to a seatback 2. The second duct 4-2 has a portion including a corrugated pipe 4-3 in consideration of the rotational trajectory of the seatback 2.

When the seatback 2 is folded, as shown in FIG. 1B, the length of the second duct 4-2 may be increased by the corrugated pipe 4-3. However, because the second duct 4-2 including the corrugated pipe 4-3 is exposed, the second duct 4-2 may be damaged by the interference with surrounding components or external force.

Moreover, when it is impractical to connect the blower 3 to the second duct 4-2 in order to fold the seatback 2, a blower 3 to blow air to the seatback 2 may be, as shown in FIG. 2, separately mounted in addition to the blower 3 mounted in the seat cushion 1, which causes increase in weight and cost.

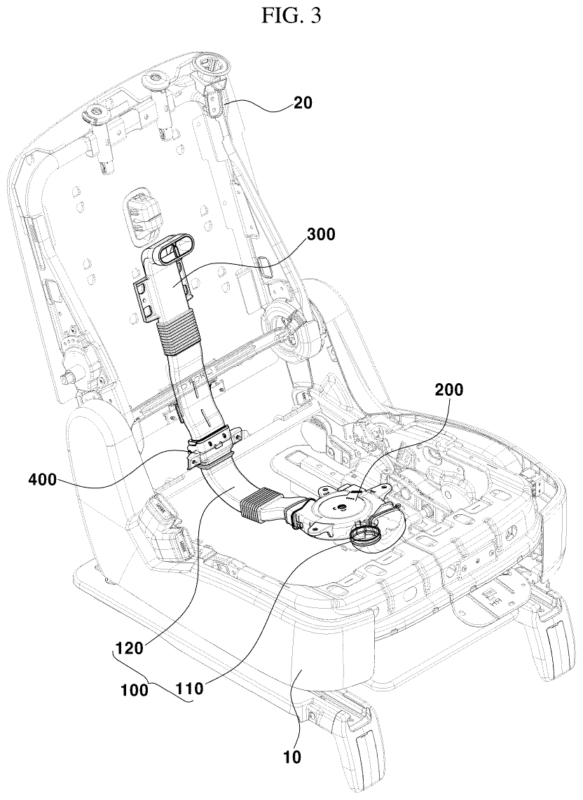

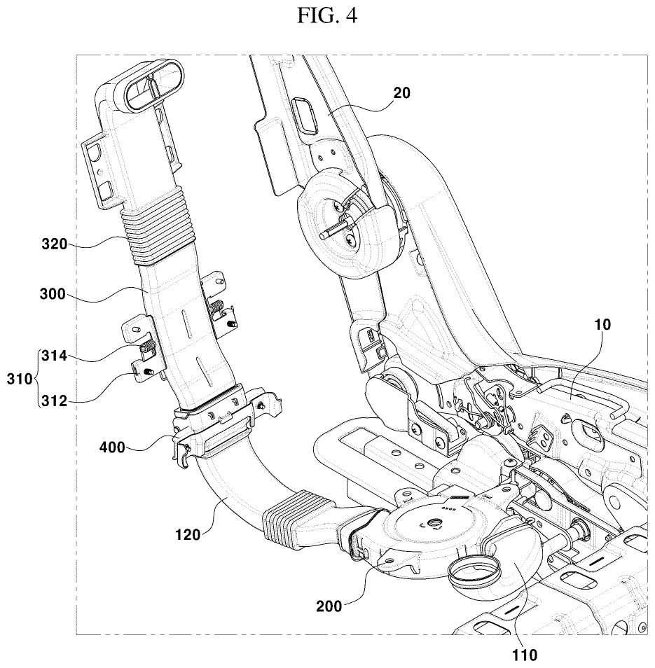

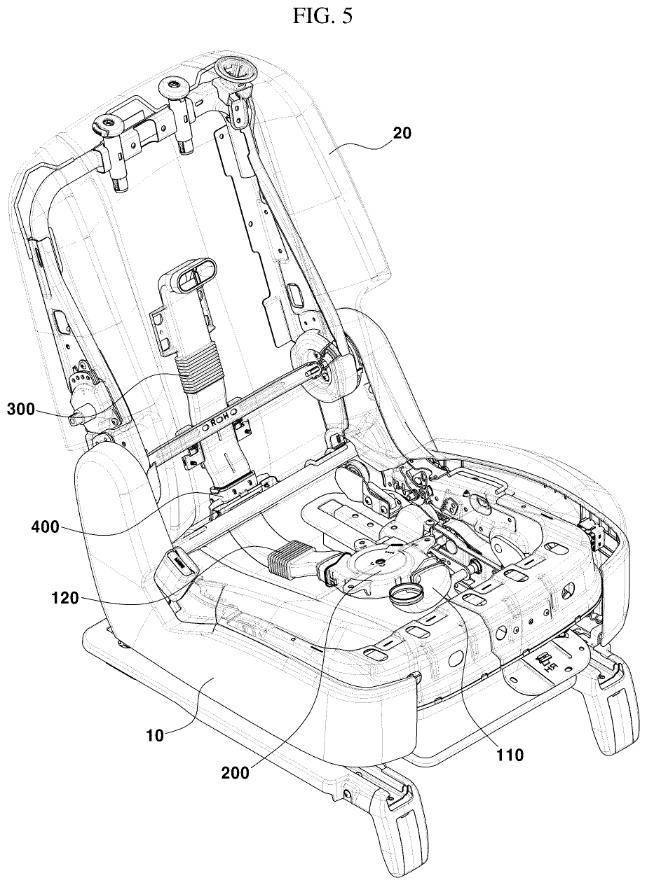

FIG. 3 show an example of a duct docking apparatus for a ventilation seat of a vehicle according to an example of the present disclosure, and FIG. 4 and FIG. 5 show an example of an air supply path for a duct docking apparatus for a ventilation seat of a vehicle according to an example of the present disclosure.

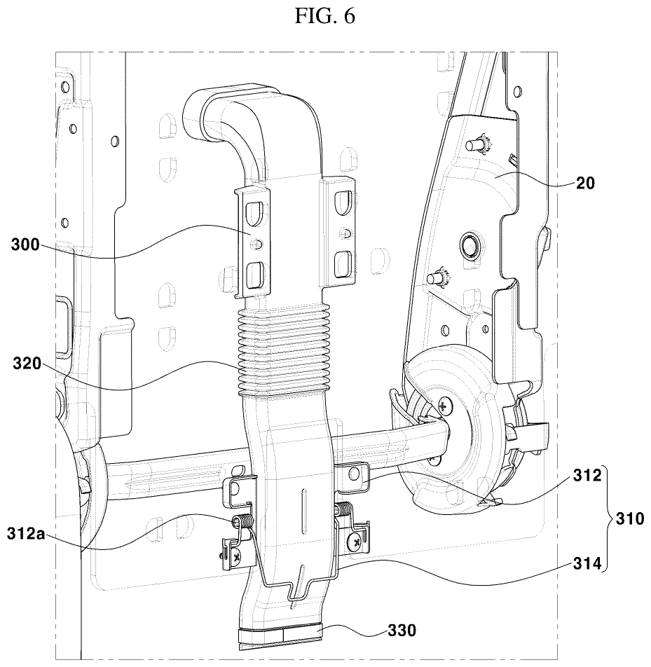

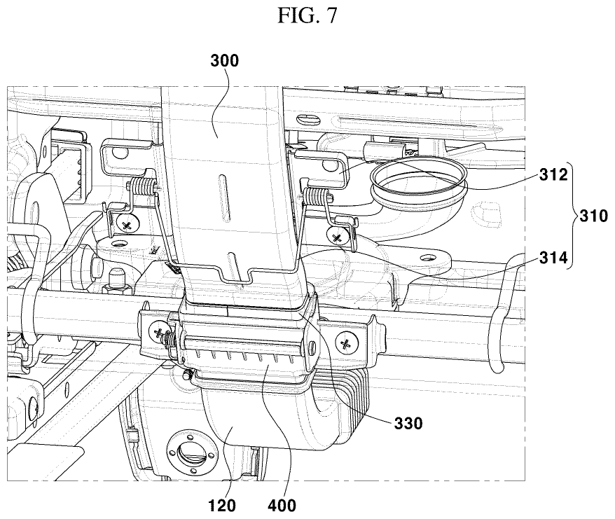

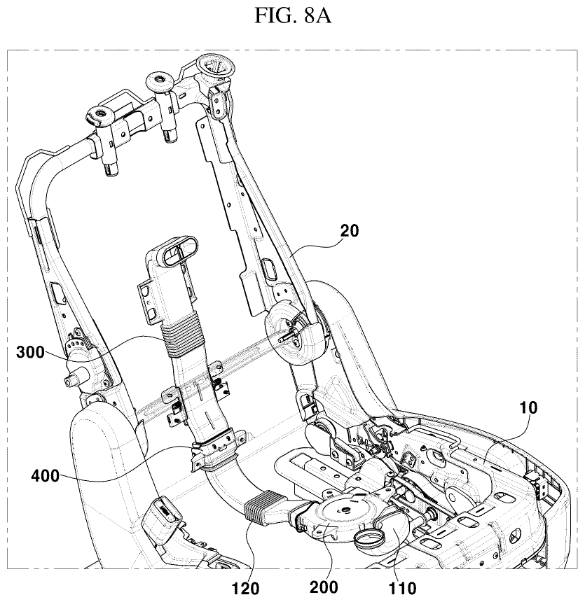

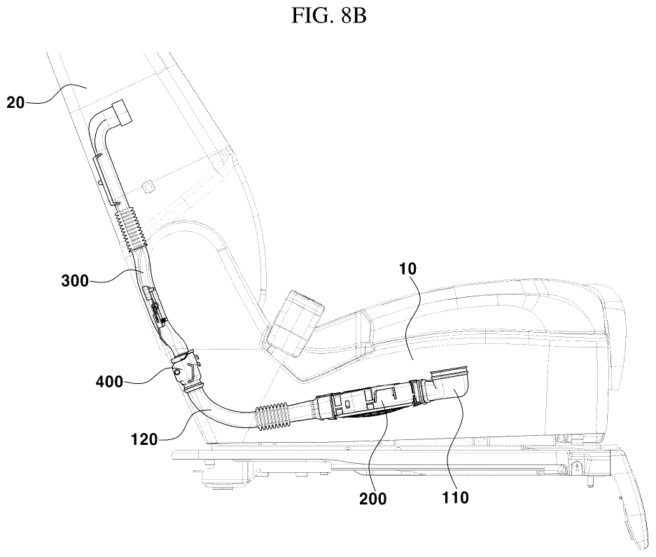

FIG. 6 show an example of a seatback duct for a duct docking apparatus for a ventilation seat of a vehicle according to an example of the present disclosure, FIG. 7 show an example of a docking connect for a duct docking apparatus for a ventilation seat of a vehicle according to an example of the present disclosure, and FIG. 8A and FIG. 8B show an example of the unfolded position of a seatback for a duct docking apparatus for a ventilation seat of a vehicle according to an example of the present disclosure.

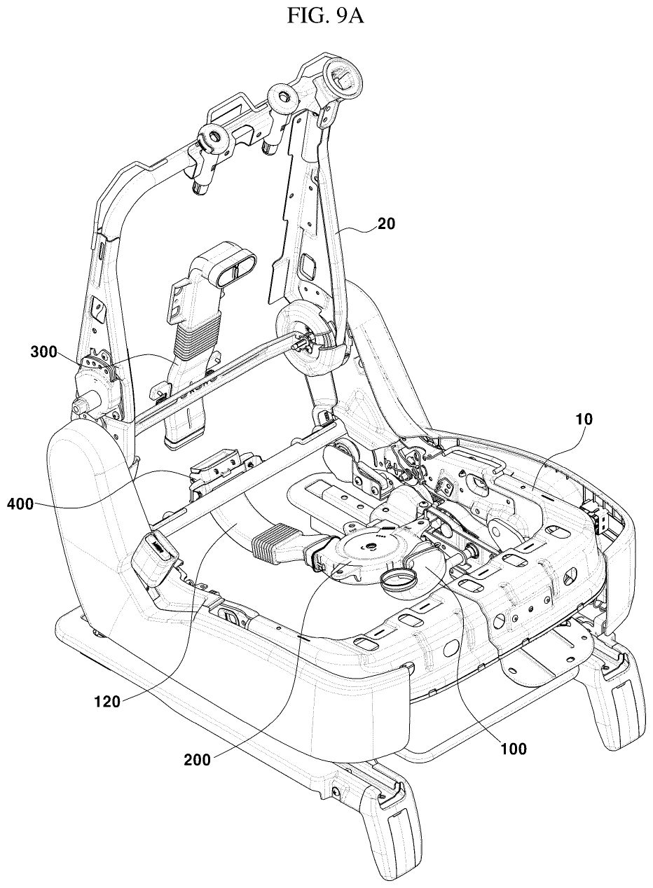

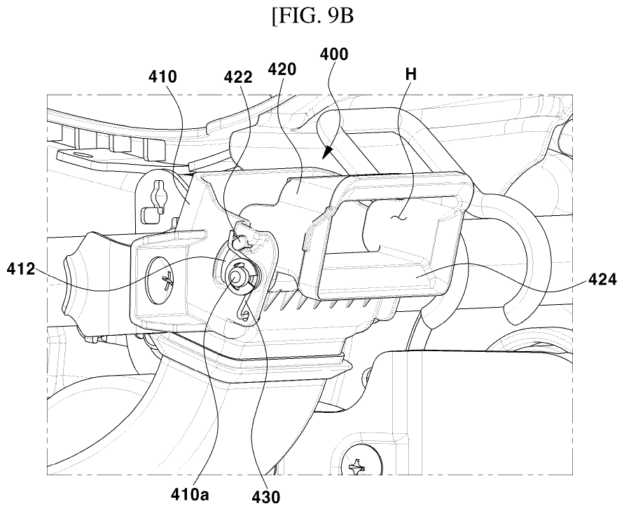

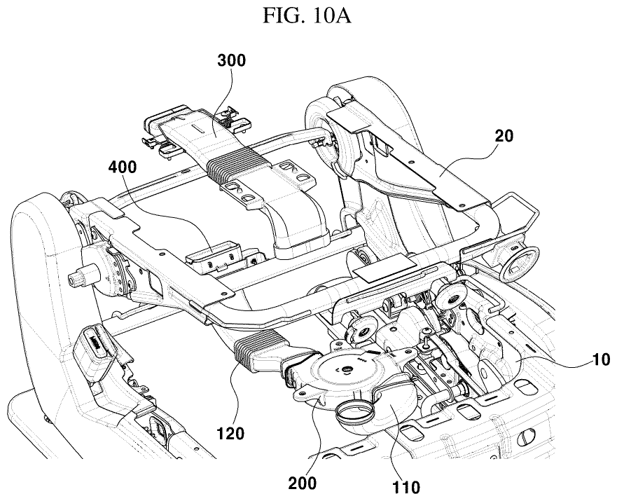

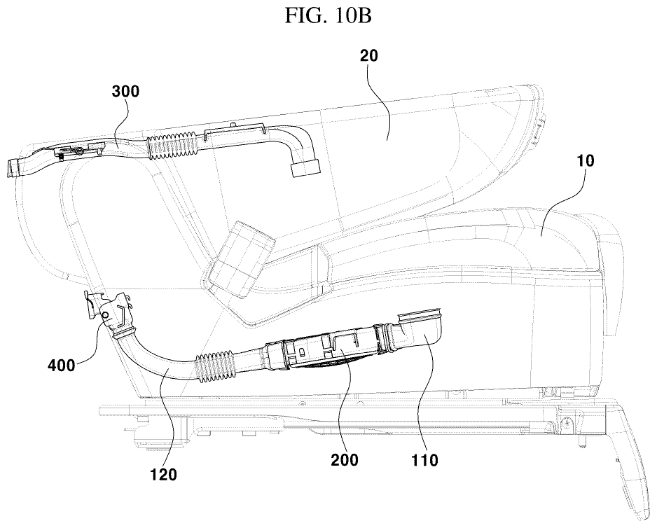

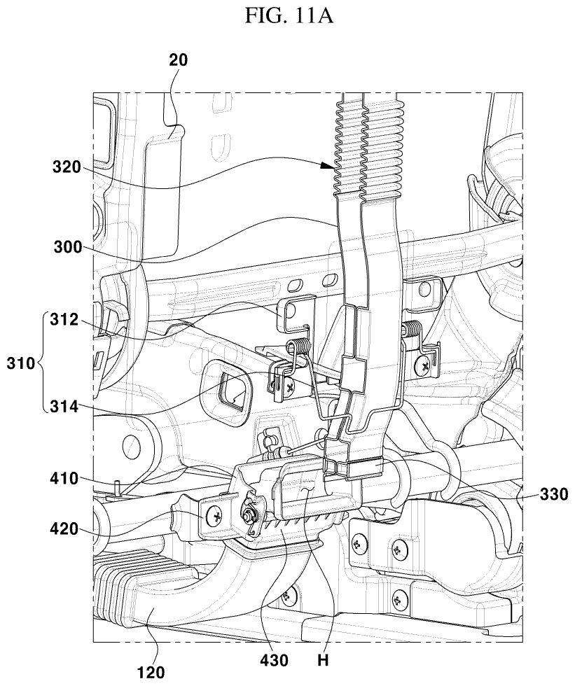

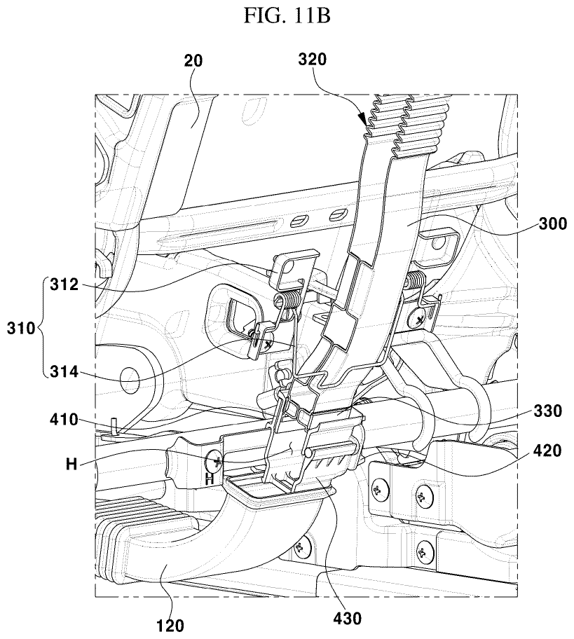

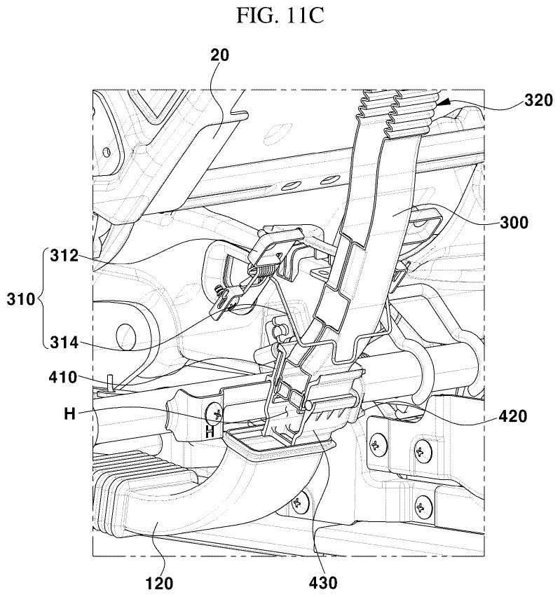

FIG. 9A and FIG. 9B show an example of the rotation of a seatback for a duct docking apparatus for a ventilation seat of a vehicle according to an example of the present disclosure, FIG. 10A and FIG. 10B show an example of the folded position of a seatback for a duct docking apparatus for a ventilation seat of a vehicle according to an example of the present disclosure, and FIG. 11A, FIG. 11B, and FIG. 11C sequentially show an example of the docking of a seatback duct to a duct docking apparatus for a ventilation seat of a vehicle according to an example of the present disclosure.

As shown in FIG. 3, a duct docking apparatus for a ventilation seat of a vehicle according to the present example includes a seat cushion duct 100, a blower 200, a seatback duct 300, and a docking connect 400.

As shown in FIG. 4, the seat cushion duct 100 is divided into a first seat cushion duct 110 and a second seat cushion duct 120, and configured to supply air to a seat cushion 10.

Specifically, the seat cushion duct 100 is connected to one side and another side of the blower 200, respectively. The first seat cushion duct 110 connected to the one side of the blower 200 may be used as an air passage for discharging air to passenger's lower body including the passenger's bottom, and the second seat cushion duct 120 connected to the other side of the blower 200 may be used as an air passage for discharging air to passenger's upper body including the passenger's back.

The blower 200 is mounted between the first seat cushion duct 110 and the second seat cushion duct 120 to blow air into the seat cushion duct 100.

Furthermore, the blower 200 operates as the ventilation seat is operated by the passenger, discharging air into the first seat cushion duct 110, the second seat cushion duct 120, and the seatback duct 300 in the direction of the arrows in FIG. 5.

Accordingly, as shown in FIG. 5, the blower 200 discharges air to the lower body of the passenger through the first seat cushion duct 110 in the seat cushion 10, and discharges air to the upper body of the passenger through the second seat cushion duct 120 and the seatback duct 300 connected to the second seat cushion duct 120 in the seatback 20.

The seatback duct 300 may be, by being mounted to the seatback 20, communicably docked to the second seat cushion duct 120 or separated from the second seat cushion duct 120 by being rotated together with the seatback 20 when the seatback 20 rotates to a folded position with respect to the seat cushion 10.

The seatback duct 300 may be mounted at the center of the seatback 20, and may be docked in a straight direction to the second seat cushion duct 120 of the seat cushion duct 100 mounted at the center of the seat cushion 10 through the docking connect 400.

As described above, the second seat cushion duct 120 and the seatback duct 300 are docked in a straight direction to each other in the seat cushion 10 and the seatback 20, reducing the length of the duct and simplifying the path of the duct. Accordingly, the loss of the amount of air discharged from the blower 200 may be minimized, improving the airflow performance of the ventilation seat.

Moreover, the seatback duct 300 may include a corrugated structure 320 in the lengthwise direction thereof. Owing to the corrugated structure 320, when the seatback 20 is adjusted in angle while the seatback duct 300 is docked to the second seat cushion duct 120, the seatback duct 300 may maintain the connection to the docking connect 400 by being selectively deformed.

Further, the seatback duct 300 may be provided with, as shown in FIG. 6, a fixation guide 310 configured to fix the seatback duct 300 in place in the seatback 20.

The fixation guide 310 may include a mounting bracket 312 and an elastic member 314.

The mounting bracket 312 is provided in a pair. One of the pair is coupled to a left portion of the seatback 20 and the other one of the pair is coupled to a right portion of the seatback 20. With this structure, the mounting bracket 312 may support the movement of the seatback duct 300 in left and right directions in the seatback 20.

The elastic member 314 is rotatably connected to connecting members 312a, each provided on each of the pair of the mounting bracket 312, and elastically supports the seatback duct 300 in forward direction.

Differently put, one side and another side of the elastic member 314 are each connected to a corresponding one of the connecting members 312a while being rotatably coupled to the corresponding one of the coupling members 312a, allowing the elastic member 314 to press the seatback duct 300 forward by the elastic force acting at the corresponding position.

With this structure, the elastic member 314 allows the left, right, front, and rear portions of the seatback duct 300 to be fixed in place, so that the seatback duct 300 may be aligned with the docking connect 400 in a straight direction when the seatback 20 rotates from the folded position to the unfolded position. Therefore, the seatback duct 300 may be easily docked to the second seat cushion duct 120 when the seatback 20 is in the unfolded position.

Moreover, because the elastic member 314 is rotatably coupled to the coupling members 312a, even if the seatback duct 300 changes in angle by the corrugated structure 320 when adjusting the angle of the seatback 20, the elastic supporting for the seatback duct 300 in the seatback 20 may be maintained because the elastic member 314 may rotate in the coupling members 312a (see FIG. 11C).

Meanwhile, the docking connect 400 may connect, as shown in FIG. 7, the second seat cushion duct 120 and the seatback duct 300 to each other, and may guide the docking position of the seatback duct 300 to the second seat cushion duct 120 when the seatback 20 rotates to the unfolded position.

To this end, the docking connect 400 may include, as shown in FIG. 9B, a body 410, a docking guide 420, and an elastic member 430.

The body 410 may be connected to the second seat cushion duct 120 while being fixed to the seat cushion 10 through a bolting or other joining method.

The body 410 includes a guide slot 412 into which a guide pin 422 formed on the docking guide 420 is inserted, wherein the guide slot 412 is configured to set a rotation path of the docking guide 420 rotated by the elastic member 430.

The guide slot 412 may have a curved shape so as to guide the movement of the guide pin 422 along the radius of rotation of the docking guide 420 rotating about a rotation shaft 410a.

The docking guide 420 is rotatably axially coupled to the body 410 through the rotation shaft 410a, and includes a communication hole H to enable the seatback duct 300 to be communicably docked while the body 410 is connected to the second seat cushion duct 120.

Here, the docking guide 420 may include an inlet portion 424 formed by the communication hole H gradually increasing in size, as explained in the following.

The inlet portion 424 has a stepped shape including an inclined surface in the docking guide 420 so as to be increased in size from the communication hole H. The inclined surface widens along the inlet portion 424's length such that the inclined surface guides the seatback duct 300 to alignment with the communication hole H. Therefore, while the seatback duct 300, which was separated from the second seat cushion duct 120 when the seatback 20 was in the folded position, is docked to the second seat cushion duct 120 as the seatback 20 is switched to the unfolded position, the seatback duct 300 may be stably positioned within the docking guide 420 because the inlet portion 424 has increased in size from the communication hole H.

Moreover, because the inlet portion 424 has the stepped shape including the inclined surface, when the seatback 20 is further rotated to the unfolded position while the seatback duct 300 is positioned within the docking guide 420, the seatback duct 300 may be easily guided into the communication hole H along the inclined surface.

Here, the seatback duct 300 may be provided with a sealing member 330 (see FIG. 6). The sealing member 330 is mounted to wrap around an end portion of the seatback duct 300, and is positioned at a border between the communication hole H and the inlet portion 424 so as to maintain airtightness when the seatback duct 300 is communicably docked to the second seat cushion duct 120.

Because the coupling amount for docking of the seatback duct 300 increases as the seatback 20 is further rotated in the unfolded position (see FIG. 11C), when the seatback duct 300 is inserted into and placed in the communication hole H, the sealing member 330 may block the air being discharged from leaking out between the inner surface of the communication hole H and the outer surface of the seatback duct 300.

The elastic member 430 elastically supports the guide pin 422 formed on the docking guide 420 (see FIG. 9B), and provides an elastic force to rotate the docking guide 420 from the body 410 as the seatback 20 is switched to the folded position and separated from the seat cushion duct 200.

This is to allow the docking guide 420 to rotate to a position to be connected to the seatback duct 300 by the elastic member 430. Thus, in the case where the docking guide 420 rotates in this manner, when the seatback 20 is switched from the folded position to the unfolded position, the docking guide 420 already has been rotated by only the rotation of the seatback duct 300, allowing the seatback duct 300 to be connected to the docking guide 420, thereby easily docking the seatback duct 300 to the second seat cushion duct 120 in a communicable manner.

Herein below, based on the above description regarding the structure of the duct docking apparatus for a ventilation seat of a vehicle according to the present example, switching of the seatback 20 from the unfolded state to the folded state and from the folded state to the unfolded state are sequentially described.

As shown in FIG. 8A and FIG. 8B, when the seatback 20 is in the unfolded state, the second seat cushion duct 120 and the seatback duct 300 are communicably docked to each other by the docking connect 400.

Here, when the seatback 20 is rotated, as shown in FIG. 9A, the seatback duct 300 is also rotated together therewith and is separated from the docking connect 400. When the seatback 20 is further rotated, as shown in FIG. 10A and FIG. 10B, the seatback duct 300 is also rotated together therewith in a state where the seatback duct 300 is separated from the docking connect 400.

Differently put, because a passenger cannot sit when the seatback 20 is in the folded state, the seatback duct 300 may be separated from the docking connector 400, and for this reason, the operation of the ventilation seat in which air is discharged to the seat cushion 10 and seatback 20 by the blower 200 is allowed to be performed only if the docking connect 400 and the seatback duct 300 are connected to each other. Accordingly, there is no need to add an additional blower for blowing air to the seatback 20, realizing weight reduction and cost reduction.

Meanwhile, when the seatback 20 is switched from the folded state to the unfolded state, first, as shown in FIG. 11A, the seatback 20 is rotated to move to the unfolded position, and the seatback duct 300 rotates together therewith to be positioned adjacent to the docking guide 420.

Here, because the docking guide 420 is in a state of being rotated by the elastic member 430 to a position to be connected to the seatback duct 300 at the point when the docking guide 420 is separated from the seatback duct 300, when the seatback 20 is rotated, as shown in FIG. 11B, the seatback duct 300 may be connected to the docking guide 420 and communicably docked to the second seat cushion duct 120. Here, the docking guide 420 is rotated within the body 410 and is positioned in a straight line with the second seat cushion duct 120 by the seatback duct 300.

In this state, when the seatback 20 is further rotated as shown in FIG. 11C, the seatback duct 300 is also rotated together therewith, and accordingly, the seatback duct 300 is moved downward, increasing the coupling amount in which the seatback duct 300 is inserted into the docking guide 420.

When the seatback duct 300 is docked to the second seat cushion duct 120 through the docking guide 420 as described above, the sealing member 330 is positioned inside the communication hole H as the coupling amount of the seatback duct 300 increases, whereby a reliable sealing is maintained between the seatback duct 300 and the communication hole H, and as a result, enabling effective operation of the ventilation seat.

The present disclosure has been made in an effort to solve the above-described problems, and an object of the present disclosure is to provide a duct docking apparatus for a ventilation seat of a vehicle, wherein the apparatus has a feature in which a seatback duct mounted to a seatback and a seat cushion duct mounted to a seat cushion are airtightly docked to each other via a connector duct or the like when the seatback is in an unfolded position, etc. where a passenger may be seated, and the seatback duct and the seat cushion duct are separated from each other when the seatback is in a folded position considering that a passenger may not be seated, thereby allowing air to be easily blown to the seatback and to the seat cushion using only one blower while a passenger is seated on the seat.

In one example, the present disclosure provides a duct docking apparatus for a ventilation seat of a vehicle, wherein the apparatus includes a seat cushion duct divided into a first seat cushion duct and a second seat cushion duct and configured to supply air to a seat cushion, a blower mounted between the first seat cushion duct and the second seat cushion duct to blow air into the seat cushion duct, a seatback duct configured to be, by being mounted to a seatback that is rotatably connected to the seat cushion, communicably docked to the seat cushion duct or separated from the seat cushion duct when the seatback rotates to a folded position, and a docking connect configured to connect the seat cushion duct to the seatback duct and to guide a docking position of the seatback duct to the seat cushion duct when the seatback rotates to an unfolded position.

In an example, the docking connect may include a body connected to the seat cushion duct, a docking guide rotatably coupled to the body and including a communication hole to enable the seatback duct to be communicably docked, and an elastic member configured to elastically support a guide pin formed on the docking guide, and to provide an elastic force to rotate the docking guide from the body when the seatback is switched to the folded position and separated from the seat cushion duct.

In another example, the body may include a guide slot into which the guide pin is inserted. Here, the guide slot may set a rotation path of the docking guide rotated by the elastic member.

In still another example, the docking guide may include an inlet portion formed by the communication hole gradually increasing in size.

In yet another example, the seatback duct may include, regarding the seatback duct being communicably docked to the seat cushion duct, a sealing member positioned at a border between the communication hole and the inlet portion to maintain airtightness.

In still yet another example, the sealing member may be positioned inside the communication hole as the seatback is further rotated in the unfolded position and a coupling amount for docking of the seatback duct increases.

In a further example, the seatback duct may be mounted at the center of the seatback and may be docked in a straight direction to the seat cushion duct mounted at the center of the seat cushion through the docking connect.

In another further example, the seatback duct may be provided with a fixation guide configured to fix the seatback duct in place in the seatback.

In still another further example, the fixation guide may include a mounting bracket configured to support the seatback duct in left right directions, and an elastic member mounted to the mounting bracket and configured to elastically support the seatback duct in forward direction.

In another example, the present disclosure provides a duct docking apparatus for a ventilation seat of a vehicle, wherein the apparatus includes a seat cushion duct divided into a first seat cushion duct and a second seat cushion duct and configured to supply air to a seat cushion at a center of the seat cushion, a blower mounted between the first seat cushion duct and the second seat cushion duct to blow air into the seat cushion duct, a seatback duct configured to be, by being mounted to a center of a seatback that is rotatably connected to the seat cushion, communicably docked to the seat cushion duct in a straight direction or separated from the seat cushion duct when the seatback rotates to a folded position, and a docking connect configured to connect the seat cushion duct to the seatback duct and to guide a docking position of the seatback duct to the seat cushion duct when the seatback rotates to an unfolded position.

In an example, the docking connect may include a body connected to the seat cushion duct, a docking guide rotatably coupled to the body and including a communication hole to enable the seatback duct to be communicably docked, and an elastic member configured to elastically support a guide pin formed on the docking guide, and to provide an elastic force to rotate the docking guide from the body when the seatback is switched to the folded position and separated from the seat cushion duct.

In another example, the body may include a guide slot into which the guide pin is inserted. Here, the guide slot may set a rotation path of the docking guide rotated by the elastic member.

In still another example, the docking guide may include an inlet portion formed by the communication hole gradually increasing in size.

In yet another example, the seatback duct may include, regarding the seatback duct being communicably docked to the seat cushion duct, a sealing member positioned at a border between the communication hole and the inlet portion to maintain airtightness.

In still yet another example, the sealing member may be positioned inside the communication hole as the seatback is further rotated in the unfolded position and a coupling amount for docking of the seatback duct increases.

In a further example, the seatback duct may be provided with a fixation guide configured to fix the seatback duct in place in the seatback.

In another further example, the fixation guide may include a mounting bracket configured to support the seatback duct in left right directions, and an elastic member mounted to the mounting bracket and configured to elastically support the seatback duct in forward direction.

As is apparent from the above description, the present disclosure provides the following effects.

According to the present disclosure, a seatback duct mounted to a seatback and a seat cushion duct mounted to a seat cushion may be airtightly docked to each other via a connector duct or the like when the seatback is in an unfolded position, etc. where a passenger may be seated, and the seatback duct and the seat cushion duct may be separated from each other when the seatback is in a folded position considering that a passenger may not be seated, allowing air to be easily blown to the seatback and to the seat cushion using only one blower while the passenger is seated on the seat.

Accordingly, air may be blown to the seatback and seat cushion using one blower, and thus, it is not necessary to additionally mount a blower inside the seatback in addition to the blower mounted to the seat cushion, realizing weight reduction and cost reduction.

Moreover, according to the present disclosure, the seatback duct and the seat cushion duct are docked to each other in the unfolded position by positioning the seatback duct at the center of the seatback and positioning the seat cushion duct at the center of the seat cushion, reducing the length of the duct and simplifying the shape of the path of the duct, thereby minimizing the flow loss, and thus improving the airflow performance of the ventilation seat.

Furthermore, according to the present disclosure, the blower is mounted at the bottom of the seat cushion, which is far from the passenger's head, reducing the operation noise of the blower sensed by the passenger.

In the above, example(s) of the present disclosure have been described with reference to the accompanying drawings. However, those skilled in the art to which the present disclosure pertains will understand that various modifications may be made therefrom, and that all or part of the above-described example(s) may be selectively combined. Therefore, the true technical protection scope of the present disclosure should be determined by the technical ideas of the appended claims.

What is claimed:

1. An apparatus for a ventilation seat of a vehicle, the apparatus comprising:
a seat cushion duct divided into a first seat cushion duct and a second seat cushion duct, and configured to supply air to a seat cushion;
a blower mounted between the first seat cushion duct and the second seat cushion duct, and configured to blow air into the seat cushion duct;
a seatback duct mounted at a seatback, which is rotatably connected to the seat cushion, wherein the seatback duct is configured to be:
based on the seatback rotating to an unfolded position, communicably docked to the seat cushion duct; and
based on the seatback rotating to a folded position, separated from the seat cushion duct; and
a docking connector configured to:
connect the seat cushion duct to the seatback duct; and
guide, based on the seatback rotating to the unfolded position, a docking position of the seatback duct to the seat cushion duct.

2. The apparatus of claim 1, wherein the docking connector comprises:
a body connected to the seat cushion duct;
a docking guide rotatably coupled to the body and comprising a communication hole configured to enable the seatback duct to be communicably docked; and
an elastic member configured to:
elastically support a guide pin formed on the docking guide, and
provide an elastic force to rotate the docking guide from the body based on the seatback being switched to the folded position and separated from the seat cushion duct.

3. The apparatus of claim 2, wherein the body comprises a guide slot into which the guide pin is inserted, and wherein the guide slot is configured to set a rotation path of the docking guide rotated by the elastic member.

4. The apparatus of claim 2, wherein the docking guide comprises an inlet portion formed by the communication hole, wherein the inlet portion has a stepped shape with an inclined surface that widens along a lengthwise direction of the inlet portion, and wherein the inclined surface guides the seatback duct to alignment with the communication hole.

5. The apparatus of claim 4, wherein the seatback duct comprises, based on the seatback duct being communicably docked to the seat cushion duct, a sealing member, positioned at a border between the communication hole and the inlet portion, configured to maintain airtightness.

6. The apparatus of claim 5, wherein the sealing member is positioned inside the communication hole based on the seatback being further rotated in the unfolded position and a coupling amount for docking the seatback duct increasing, wherein the coupling amount corresponds to an extent to which the seatback duct is coupled with the communication hole.

7. The apparatus of claim 1, wherein the seatback duct is mounted at a center of the seatback, and wherein the seatback duct is docked in a straight direction to the seat cushion duct mounted at a center of the seat cushion through the docking connector.

8. The apparatus of claim 1, wherein the seatback duct is provided with a fixation guide, and wherein the fixation guide is configured to fix the seatback duct in the seatback.

9. The apparatus of claim 8, wherein the fixation guide comprises:
a mounting bracket configured to support the seatback duct in a lateral direction; and
an elastic member mounted to the mounting bracket and configured to elastically support the seatback duct in a forward direction perpendicular to the lateral direction.

10. An apparatus for a ventilation seat of a vehicle, the apparatus comprising:
a seat cushion duct divided into a first seat cushion duct and a second seat cushion duct, and configured to supply air to a seat cushion at a center of the seat cushion;
a blower mounted between the first seat cushion duct and the second seat cushion duct, and configured to blow air into the seat cushion duct;
a seatback duct mounted at a center of a seatback, which is rotatably connected to the seat cushion, wherein the seatback duct is configured to be:
based on the seatback rotating to an unfolded position, communicably docked in a straight direction to the seat cushion duct; and
based on the seatback rotating to a folded position, separated from the seat cushion duct; and
a docking connector configured to:
connect the seat cushion duct to the seatback duct; and
guide, based on the seatback rotating to the unfolded position, a docking position of the seatback duct to the seat cushion duct.

11. The apparatus of claim 10, wherein the docking connector comprises:
a body connected to the seat cushion duct;
a docking guide rotatably coupled to the body and comprising a communication hole configured to enable the seatback duct to be communicably docked; and
an elastic member configured to:
elastically support a guide pin formed on the docking guide, and
provide an elastic force to rotate the docking guide from the body based on the seatback being switched to the folded position and separated from the seat cushion duct.

12. The apparatus of claim 11, wherein the body comprises a guide slot into which the guide pin is inserted, and wherein the guide slot is configured to set a rotation path of the docking guide rotated by the elastic member.

13. The apparatus of claim 11, wherein the docking guide comprises an inlet portion formed by the communication hole, wherein the inlet portion has a stepped shape with an inclined surface that widens along a lengthwise direction of the inlet portion, and wherein the inclined surface guides the seatback duct to be aligned with the communication hole.

14. The apparatus of claim 13, wherein the seatback duct comprises, based on the seatback duct being communicably docked to the seat cushion duct, a sealing member, positioned at a border between the communication hole and the inlet portion, configured to maintain airtightness.

15. The apparatus of claim 14, wherein the sealing member is positioned inside the communication hole based on the seatback being further rotated in the unfolded position and a coupling amount for docking of the seatback duct increasing, wherein the coupling amount corresponds to an extent to which the seatback duct is coupled with the communication hole.

16. The apparatus of claim 10, wherein the seatback duct is provided with a fixation guide, and wherein the fixation guide is configured to fix the seatback duct in the seatback.

17. The apparatus of claim 16, wherein the fixation guide comprises:
a mounting bracket configured to support the seatback duct in a lateral direction; and
an elastic member mounted to the mounting bracket and configured to elastically support the seatback duct in a forward direction perpendicular to the lateral direction.

18. A method performed by a vehicle for a ventilation seat of the vehicle, the method comprising:
supplying air to a seat cushion through a seat cushion duct divided into a first seat cushion duct and a second seat cushion duct;
blowing air into the seat cushion duct using a blower mounted between the first seat cushion duct and the second seat cushion duct;
rotating a seatback, which is rotatably coupled to the seat cushion, to an unfolded position, wherein during the seatback being rotated to the unfolded position, a seatback duct mounted at the seatback communicably docks with the seat cushion duct to enable air flow;
rotating the seatback to a folded position, wherein during the seatback being rotated to the folded position, the seatback duct separates from the seat cushion duct to discontinue air flow; and
guiding, by a docking connector of the vehicle and based on rotating the seatback to the unfolded position, a docking position of the seatback duct to align with the seat cushion duct to facilitate air flow.

19. The method of claim 18, wherein the docking connector comprises:
a body connected to the seat cushion duct;
a docking guide rotatably coupled to the body and comprising a communication hole configured to enable the seatback duct to be communicably docked; and
an elastic member configured to:
elastically support a guide pin formed on the docking guide, and
provide an elastic force to rotate the docking guide from the body based on the seatback being switched to the folded position and separated from the seat cushion duct.

20. The method of claim 19, wherein the body comprises a guide slot into which the guide pin is inserted, and wherein the guide slot is configured to set a rotation path of the docking guide rotated by the elastic member.
